(19) United States
(12) Patent Application Publication
(10) Pub. No.: US 2005/0278754 A1
(43) Pub. Date: Dec. 15, 2005

(54) System for delivering multimedia content to airline passengers

(75) Inventors: Brett Bleacher, Irvine, CA (US); Mark Thompson, Rancho Santa Margarita, CA (US)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: Thales Avionics, Inc., Irvine, CA (US)

(21) Appl. No.: 11/137,011

(22) Filed: May 25, 2005

Related U.S. Application Data
(60) Provisional application No. 60/574,894, filed on May 27, 2004.

(51) Int. Cl. H04N 7/18

(52) U.S. Cl. 725/77; 725/76

(57) ABSTRACT

A system for delivering multimedia content to airline passengers is provided. According to various implementations, the system has a video display unit disposed proximate to a seat to which the aircraft passenger is assigned. The video display unit itself has a display screen and a video decoder. A user input device is communicatively linked to the video display unit. When the aircraft passenger manipulates the user input device, signals representing an on-demand video are transmitted to the video display unit, and received by the video decoder. The video decoder then decodes the signals, thereby permitting the on-demand video to be displayed on the display screen.

### CROSS-REFERENCE TO RELATED APPLICATIONS

This application claims the benefit of the filing date of U.S. Provisional Application No. 60/574,894, filed May 27, 2004, which is incorporated herein by reference in its entirety.

### BACKGROUND

The air travel business is becoming increasingly competitive and commoditized, with travelers choosing among airlines largely based on price. To stay in business, airlines need to control costs. However, they still need to offer certain in-flight amenities, since passengers have grown to expect such service. An example of such an amenity is in-flight movies. Passengers generally expect to be shown at least one movie on a flight lasting more than a couple of hours. One problem with offering conventional in-flight movies, however, is that all passengers are shown the same movie, but not all passengers have the same viewing tastes. Additionally, children, who are the most restless passengers on any flight, are not interested in films for mature viewers. Thus, airlines are forced to pick movies that will hopefully have a broad appeal, while ignoring better movies that at least some passengers would prefer to see. Passengers with more discerning tastes are thus forced to bring their own personal movie players and video content, hoping that their batteries last for the duration of the flight. Another problem is that not all passengers even want to watch moves. Many passengers would prefer to pass the time browsing the Internet, or to playing video games. Again, passengers wishing to entertain themselves with these alternatives are forced to bring their own devices. Thus, it can be seen that there is a need for a system for delivering multimedia content that addresses the foregoing problems.

### SUMMARY

In accordance with the foregoing, a system for delivering multimedia content to airline passengers is provided. In an embodiment of the invention, the system has a video display unit disposed proximate to a seat to which the aircraft passenger is assigned. The video display unit itself has a display screen and a video decoder. A user input device is communicatively linked to the video display unit. When the aircraft passenger manipulates the user input device, signals representing an on-demand video are transmitted to the video display unit, and received by the video decoder. The video decoder then decodes the signals, thereby permitting the on-demand video to be displayed on the display screen.

In another embodiment of the invention, the system has a plurality of video display units, each associated with, and proximate to, one of a plurality of seats. Each video display unit has a display screen and a video decoder. There are also a plurality of user input devices, each communicatively linked with one of the plurality of video display units. The system further includes a data network located on the aircraft. Each of the plurality of user input devices is communicatively linked to the data network. The system further includes a head end unit communicatively linked to the data network, and a plurality of on-demand videos are electronically stored in therein. In response to an aircraft passenger manipulating the user input device that is communicatively linked to the video display unit associated with the seat to which the aircraft passenger is assigned, signals representing a on-demand video of the plurality of on-demand videos are transmitted to that video display unit over the data network, and are received by the video decoder of that video display unit. The video decoder decodes the signals, thereby permitting the on-demand video to be displayed on the display screen of that video display unit.

In yet another embodiment of the invention, the system includes a plurality of passenger aircraft seats are coupled to the floor of an aircraft fuselage. A local area network having a plurality of nodes is distributed throughout the aircraft, and a head end server is communicatively linked to the local area network at one of the plurality of nodes. The system further includes a plurality of video display units, each video display unit of the plurality being coupled to a seat of the plurality of seats and communicatively linked to the local area network at one of the plurality of nodes. The head end server delivers on-demand video content to one or more of the video display units via one or more RF video links. Each video display unit comprises a processor, a display screen, and a touch-sensitive interface disposed on the display screen. In response to a passenger touching the display screen, the head end server transmits on-demand video to the video display unit. The video display unit transmits data representing the hardware status of the video display unit to the head end server via the local area network.

### BRIEF DESCRIPTION OF THE DRAWINGS

FIG. 1 illustrates an embodiment of the system for delivering multimedia content described herein;

FIG. 2 is a block diagram illustrating an embodiment of the smart video display unit (SVDU);

FIG. 3 is a diagram illustrating the flow of data in an embodiment of the SVDU;

FIG. 4 illustrates an example of an interface between an SVDU and a seat electronics box (SEB);

FIG. 5 illustrates horizontal and vertical viewing angles of a display in an embodiment of the invention;

FIGS. 6-8 illustrate an exterior view of various SVDUs in various embodiments;

FIGS. 9-11 illustrate various passenger control units (PCUs) in various embodiments of the invention;

FIGS. 12-15 illustrate various types of content that may be shown on the SVDU; and

FIG. 16 illustrates a possible configuration screen for the SVDU.

### DETAILED DESCRIPTION

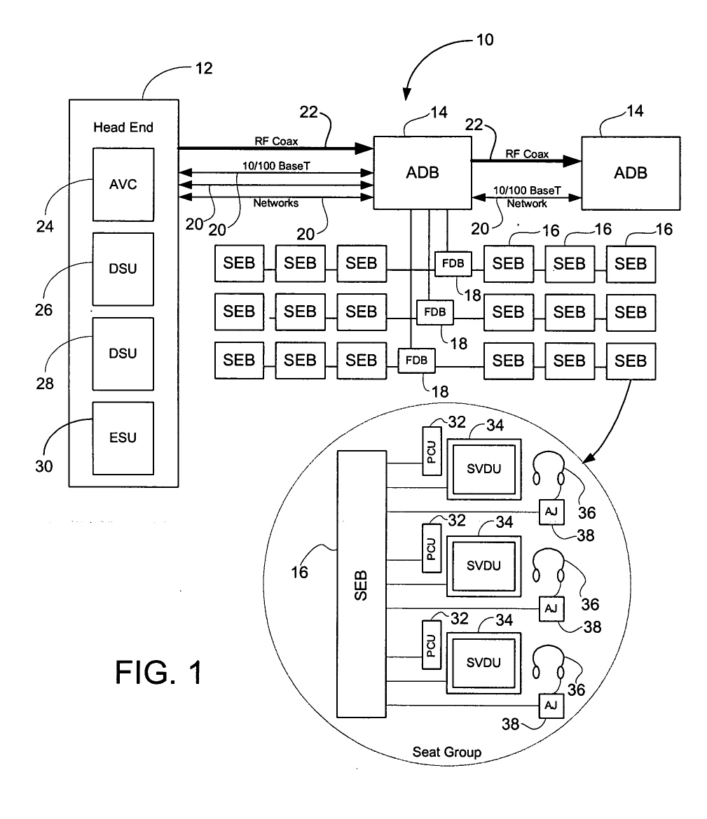

Referring to FIG. 1, an in-flight media delivery system configured in accordance with an embodiment of the invention is shown. The system, generally labeled 10, includes a head end unit 12, one or more area distribution boxes (ADBs) 14, one or more seat electronic boxes (SEBs) 16, one or more floor disconnect boxes (FDBs) 18, a local area network (LAN) 20, and one or more RF links 22. The head end unit 12 includes an audio-video controller (AVC) 24, a first digital server unit (DSU) 26, a second DSU 28, and an Ethernet switching unit (ESU) 30. The head end 12 is communicatively linked to the ADBs 14, and the ADBs 14 are communicatively linked to one another, via the LAN 20 and the RF links 22. As shown in FIG. 1, each ADB 14 is communicatively linked to one or more of the FDBs 18. The FDBs 18 are, in turn, communicatively linked to the SEBs 16. The LAN 20 and the RF links 22 may be implemented in a variety of ways, but are depicted in FIG. 1 as an Ethernet-based network and RF coaxial links, respectively. It is understood that the LAN 20 may be wireless, and that the RF links may alternatively be digital. Additionally, the LAN 20 may be implemented as Gigabit Ethernet networks.

Referring still to FIG. 1, each SEB 16 is associated with a group of passenger seats (“seat group”). There may be any number of seats in a seat group, but three are depicted in FIG. 1. Associated with each seat in a seat group is a passenger control unit (PCU) 32, a smart video display unit (SVDU) 34, and a headset 36 that plugs into an audio jack (AJ) 38. The SEB 16 is communicatively linked to the PCU 32, the SVDU 34, and the AJ 38. Each SVDU 34 is associated with one of the SEBs 16.

According to an embodiment of the invention, the SVDU 34 is a terminal that a passenger can use to communicate over the LAN 20. The SVDU 34 may be mounted in a variety of locations in the cabin, such as on a seat-back, on an arm mount, or on the cabin wall. Each SVDU 34 includes a display and a housing. The SVDU 34 is made out of materials selected so as to make it compliant with applicable aircraft regulations. For example, FR-4 material is used on circuit board assemblies. Exterior surfaces of the SVDU 34 are designed to withstand exposure to isopropyl alcohol, household ammonia, food acids (e.g. lemon juice and soft drinks) and commercial cleaning agents. Furthermore, all exterior surface finishes of the SVDU 34 are designed to withstand the abrasion of industrial cleaning pads soaked in commercial cleaning agents. Additionally, the SVDU 34 is designed in accordance with standard Human Engineering design criteria and principles so as to maximize safety, maintainability and reliability.

In an embodiment of the invention, the SVDU 34 includes a liquid crystal display (LCD) that has a backlight. The estimated mean time between failures of the LCD in an embodiment of the invention, excluding the LCD backlight, is listed in the table below:

| LCD SIZE | MTBF | MTBF |
|---|---|---|
| (inches) | (Target) | (Guarantee) |
| 8.4 | 42,000 | 34,000 |
| 10.4 | 40,000 | 32,000 |

The backlight of the SVDU 34 in this embodient has a brightness half-life of 10,000 hours or greater. Preferably, the Mean Time To Repair (MTTR) the SVDU 34 is less than 18 minutes. The MTTR includes the time it takes to remove and replace the SVDU 34, load the appropriate operating software, and perform a return-to-service test.

The height and width of the SVDU 34 as a whole are preferably as close as possible to the total height and width of the display. In one embodiment, the SVDU is available in 8.4 inch, 10.4 inch and 15 inch display sizes, with the entire SVDU 34 (including its housing) having a maximum thickness of 1.76 inches. The SVDU has sufficient processing power, memory, graphics capability, and MPEG 1 & 2 decoding capability to act as a multimedia presentation device. The SVDU 34 presents information to a passenger, including NTSC-based video received from the SEB 16, internally generated graphics, and MPEG digital video and audio that it receives over the LAN 20 and decodes internally. The SVDU also generates analog audio output. When used in conjunction with the SEB 16, each SVDU 34 has full access to the LAN 20, thereby allowing the system 10 to present video graphics, video-on-demand, audio-on-demand, local games, and web content to each passenger. The passenger's access to the LAN 20 also allows the passenger to play network-based games with other passengers over the LAN 20 or over the Internet. Other types of content that may be delivered to the passengers includes satellite TV, digital radio, external internet (from an external provider), web portal access, eBook content, all types of MPEG contect (including MPEG-4), picture in picture, and voice over IP (VoIP). This content may be obtained from electronic storage that is internal to the aircraft, from a land connection (when the aircraft is on the ground), or from various wireless connections, such as Swift-64 and Ku-band data communications.

Each SVDU 34 may have a high-resolution touch panel that is coupled to the display of the SVDU 34. The passenger can interact with and control the SVDU 34 through the touch panel. The SVDU 34 may be powered on whenever entertainment services are available to the passenger. When entertainment services are discontinued, such as during a safety demonstration by the flight crew, the power to the SVDU may be turned off via its corresponding SEB 16.

The SVDU 34 includes a full duplex 10/100BaseT network interface that permits the SVDU 34 to communicate with the other components of the system 10 via the LAN 20. This interface supports 10BaseT as specified in IEEE802.3x, 100BaseT as specified in IEEE802.3x, and can auto sense the operating speed as specified in IEEE802.3x. The SVDU 34 may support a variety of high-level and low-level networking protocols, including User Datagram Protocol (UDP), Transmission Control Protocol (TCP), and File Transfer Protocol (FTP). The SVDU 34 also includes a pair of USB type A connectors, which are sufficiently sealed and appropriately positioned to tolerate liquid spills.

In an embodiment of the invention, each SVDU 34 has a MAC address that uses the form: 00-06-CF-xx-xx-xx. The SVDU 34 can support two different MAC Addresses—a factory-assigned MAC address and a system-assigned MAC address. The factory assigned MAC address is stored in non-volatile memory of the SVDU 34, and remains unmodified for the life of the SVDU 34. In contrast, the system-assigned MAC address is stored in volatile memory, and is assigned on each boot-up of the SVDU. The system-assigned MAC address may be modified by the system 10. To modify the system assigned MAC address, the system 10 sends out a “MAC address assignment message,” which the Ethernet controller in the SVDU 34 receives. The Ethernet controller responds by modifying the current MAC address in volatile memory to match the MAC address indicated in the assignment message. Having a system assigned MAC address optimizes the performance of the system 10 (in particular the Ethernet switches). The SVDU 34 can also revert back to its factory assigned MAC address. To cause the SVDU 34 to revert back to its factory-assigned MAC address, the system 10 transmits a “Restore Factory MAC Address” message, which the Ethernet controller of the SVDU 34 receives. In response, the Ethernet controller retrieves the factory-assigned MAC address from the non-volatile memory and stores it in volatile memory.

The SVDU 34 uses an Internet Protocol address to identify itself to the LAN 20. The SVDU 34 may use a default IP address of 192.x.x.x when no IP address has been provided by the system 10. To assign an IP address to the SVDU 34, the system 10 may perform an IP Sequencing process, an embodiment of which is described in U.S. patent application Ser. No. 11/058,037, filed Feb. 15, 2005, which is incorporated herein by reference in its entirety. Once it receives an IP address from the system 10, the SVDU 34 stores the IP address in non-volatile memory. The system-assigned IP address is used by the SVDU 34 until the system 10 assigns a new IP address sas a result of the IP Sequencing process. Additional IP addresses may be adopted by specific software components (such as a web server) in the SVDU 34 via an IP aliasing function.

In various embodiments of the invention, the display of the SVDU 34 is a color LCD screen, and the SVDU 34 further includes a housing, internal hardware within the housing that receives power, NTSC (M) video, and Ethernet data (MPEG-1/MPEG-2 streaming video/audio) from the SEB 16 associated with the SVDU 34. The internal hardware of the SVDU 34 includes a power interface printed circuit board (PCB) with a backlight inverter power supply, and a processor printed circuit board (PCB).

The SVDU 34 also includes a graphics generator that produces color graphic images for display on the LCD at the following resolutions: 640×480, 800×600, and 1024×768. It is contemplated that not all implementations of the LCD will be able to support these resolutions. Thus, the SVDU permits the selection of any of its available resolutions. Images of lower resolution (such as SIF [352×240] video images, etc.) are presented full screen on the LCD. The graphics generator supports 16-bit color and should support 24-bit color.

The SVDU 34 is also equipped with a local manual brightness control on its front. In one implementation, two buttons are provided on the front surface of the SVDU to control the brightness of the LCD. One button increases the brightness, while the other decreases it. The surfaces of the buttons are sufficiently hard to prevent or minimize damage by the passenger. The SVDU 34 may also have a third button that turns the backlight of the LCD on or off. If the backlight is off, the LCD is turned on automatically by any other action that would normally require the backlight to be on.

The SVDU 34 also includes a connector into which a commercial, non-volatile memory component such as Compact Flash, SDRAM, or PCMCIA can be inserted. The connector is located such that it is not accessible to the passenger but can be easily accessed for insertion, exchange or removal by maintenance personnel.

In one embodiment, the software that executes on the SVDU 34 is divided into two classes: boot/basic input output software (BIOS) and aircraft-loadable software. Types of aircraft loadable software include core software, common application software, and customer-specific application software. An example of core software is Acceptance Test Procedure (ATP) software or its equivalent, which performs a complete verification of the internal hardware of the SVDU 34.

An example of common application software is a web browser (such as Opera for Linux) for accessing and displaying menus, lists and other material formatted as HTML web pages. In one implementation, the browser of the SVDU 34 supports HTML 4.01 as specified in the W3C recommendation REC-HTML401 and XHTML as specified in W3C Recommendation REC-XHTML1.0. Also, the browser supports Cascading Style Sheets, Level 1 as specified in W3C recommendation REC-CSS1 and Level 2 as specified in W3C recommendation REC-CSS2. Finally, the browser of the SVDU 34 supports JavaScript as specified in ECMA-262.

Another example of common application software that may be loaded onto the SVDU 34 is a media player capable of playing MPEG material obtained from the head end server 12 (FIG. 1). The MPEG player, in conjunction with the hardware of the SVDU 34, is accessible from a browser window, and supports the requesting, buffering, demultiplexing, and decoding of either MPEG-1 or MPEG-2 material.

As manufactured, the SVDU 34 includes the boot/BIOS software, which is capable of performing a basic set of functions, including address assignment (IP and MAC), configuration reporting (“Config Check”) and software download. The software download function is used to download the aircraft loadable software.

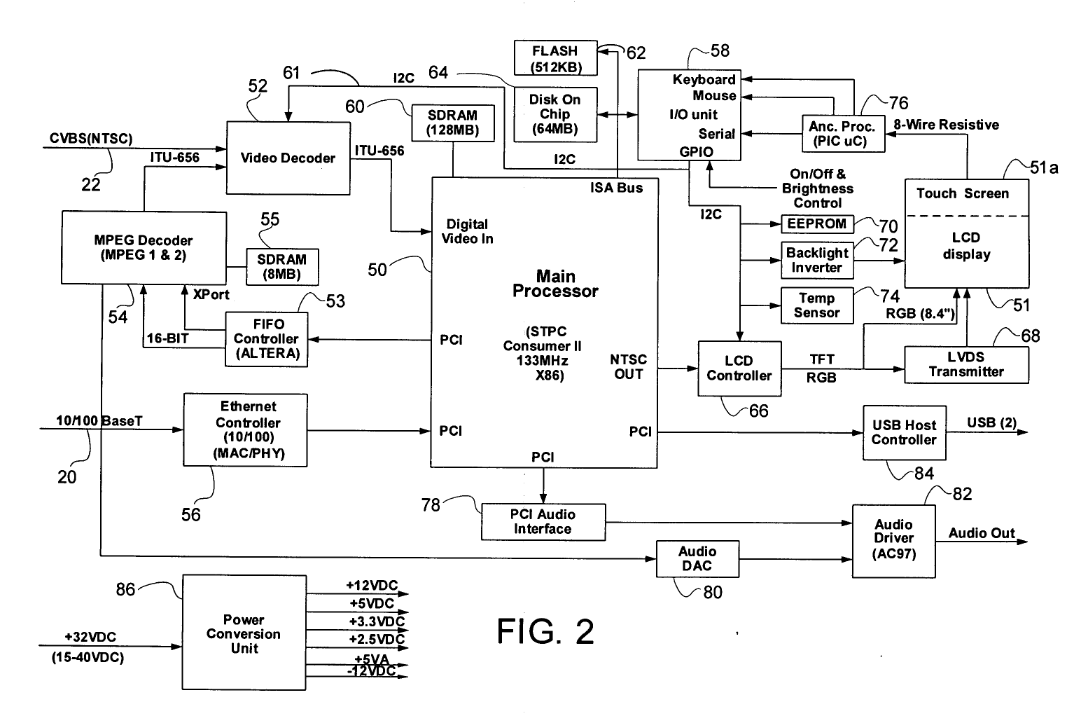

One possible configuration of the SVDU 34 will now be described with reference to FIG. 2. Note that several of the components shown in FIG. 2 have parenthetical labels, which indicate commercially available examples of the components. In the configuration shown in FIG. 2, the SVDU 34 includes a main processor 50 and an LCD 51. The SVDU 34 further includes an ISA bus 61, to which a video decoder 52, a flash memory 62, a disk-on-chip 64, an input/output (I/O) control unit 58, a liquid-crystal display (LCD) controller 66, an EEPROM 70, a backlight inverter 72, and a temperature sensor 74 are communicatively linked. The LCD 51 is coupled to a touch screen 51a. An ancillary processor 76 is linked to both the touch screen 51a and the I/O control unit 58.

The backlight inverter 72 is connected to, and operates the backlight of the LCD 51. The backlight inverter 72 is a DC-AC converter, which converts the 12 VDC to 550 Vrms nominal. The high voltage output of the backlight inverter 72 is isolated from user accessible surfaces in order to reduce the hazard of electric shock.

The temperature sensor 74 monitors the temperature of the power supply for the LCD 51, the temperature of the main processor 50, and the temperatures of the various memory components shown in FIG. 2. The SVDU 34 is cooled by natural convection and radiation.

The SVDU 34 also includes a FIFO control 53, an Ethernet controller 56, a random-access memory (RAM) 60, and a peripheral component interconnect (PCI) audio interface 78—all linked with the main processor 50 via the communication paths shown in FIG. 2. The RAM 60 may be implemented as SDRAM. The flash memory 62 has stored thereon boot/BIOS software that allows the main processor 50 to be booted. Together, the RAM 60 and the disk on chip memory 64 act as a disk emulation memory, which the main processor 50 is able to access (as if they were a single hard disk) after the boot/BIOS software is executed.

The video decoder 52 receives NTSC (National Television System Committee) video decoding and converts them to ITU-601 digital video signals. It includes horizontal and vertical video scaling for randomly sized windows and provides Closed Captioning.

The SVDU 34 further includes an MPEG decoder 54 and an MPEG memory 55, which are communicatively linked to one another. The MPEG decoder 54 is also linked to the FIFO control 53 and the video decoder 52 via the connection paths shown in FIG. 2.

Referring still to FIG. 2, the main processor 50 executes software that is stored in one or more of the various memory elements. For example, the main processor 50 may execute software of an operating system, such as Linux or Windows CE. The performance of the main processor 50 varies depending on the implementation. In one embodiment, the main processor 50 is a 200 MHz ARM processor. In another, it is a 633 MHz Pentium III processor. In yet another, the SVDU 34 has a low-power asic of a type used in the set-top box industry, such as an IBM STB PowerPC with an embedded MPEG decoder.

Referring again to FIG. 2, the SVDU has a power conversion unit 86. The power conversion unit receives unregulated +32 VDC from the SEB 16 and converts it to +2.5 VDC±5%, +3.3 VDC±5%, +5.0 VDC±5%, and +12 VDC±5% regulated power streams, which are used by the LCD 51 and the PCB electronics, and +12 VDC±5% regulated, which is used by the backlight inverter 72. The SVDU 34 provides a reset signal to the main processor 50 at power-on and when either the +3.3 VDC or +5 VDC supply voltages drop by 5%. In the SVDU 34, the chassis ground is connected from the chassis of the SVDU 34 to the shield of the inter-connected cable assembly. The chassis is preferably not connected to the DC ground within the SVDU 34.

Power consumption and power dissipation of the SVDU 34 in an embodiment of the invention are shown in the table below.

POWER REQUIREMENTS

| Characteristic | Parameter |
|---|---|
| Input Voltage | +32 VDC unregulated (nominal) |
| | (18 to 36 VDC input range) |
| Surge | 40 V for 100 ms |
| Ripple | 100 mVp-p max |
| Power | 18 Watts (w/backlight ON) |
| Consumption | 15.5 Watts (w/backlight OFF) |

Referring still to FIG. 2, the SVDU 34 further includes an LVDS transmitter 68 linked to the LCD controller 66, and an ancillary processor 76 linked to the I/O control unit 58. In an embodiment of the invention, the LCD controller is a Thin Film Transistor (TFT) panel controller. The LCD controller 66 converts RGB signals from the video decoder 52 to a TFT panel output with either one or two pixels per clock and resolution up to SXGA (1240×1024). It supports 3, 4, 6 or 8 bits per pixel up to 16.8 million colors. The LVDS transmitter 68 converts 24 bits of RGB digital data received from the LCD controller 66 into three LVDS data streams. The LVDS transmitter minimizes the EMI and cable size problems commonly associated with wide, high speed TTL interfaces.

The SVDU 34 further includes an audio driver 82 communicatively linked to both the PCI audio interface and to an audio output. Finally, the SVDU 34 includes an audio digital to analog converter (DAC) 80 communicatively linked to both the audio driver 82 and to the MPEG decoder 54.

The LCD 51 provides for the display of high resolution color images, and may be a 9, 12, 18, or 24-bit color (maximum of 16.8 million colors) panel with either a single or dual pixel clock input up to a resolution of SXGA (1024×768). The main processor 50 controls the backlight inverter 72 to turn the LCD 51 on, off, and to adjust its brightness. The main processor 50 controls the backlight inverter 72 in response to inputs from the PCU 32 (FIG. 1) or from an external interface of the SVDU 34. The SVDU 34 monitors the backlight inverter 72 so as to be able to support Built-In Test Equipment (BITE). Accordingly, when BITE is connected to the SVDU 34, the BITE can test the operation of the touch screen 51 and diagnose problems if necessary.

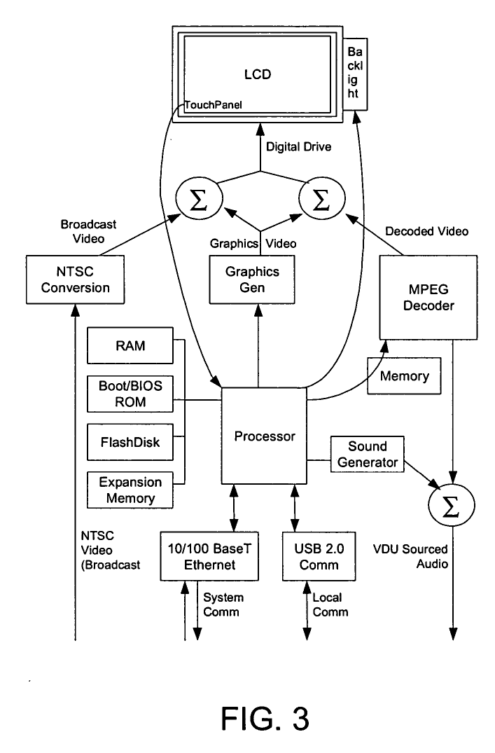

Referring to the block diagram of FIG. 2, and to the data flow diagram of FIG. 3, an example of how multimedia data flows into the SVDU and is processed by the SVDU will now be described. The SEB 16 (from FIG. 1) provides an NTSC composite video signal (EIA-RS170, EIA-RS170A, EIA-RS343, or SMPTE170M compliant) to the SVDU 34. The video signal is received by the video decoder 52, which decodes the signal and provides the resulting data to the LCD controller 66. The SVDU 34 can present the NTSC video image on the LCD 51 (FIG. 2) as a full screen or as an image in a graphics window. The SVDU 34 supports the demultiplexing of various types of digitally compressed video and audio signals received via the LANs 20, including MPEG-2 system streams (as defined in ISO 13818-1), MPEG-2 Elementary Video and Audio Streams (as defined in ISO 13818-2), MPEG-1 Video (as defined in ISO 11172-2), and audio (as defined in ISO 11172-3). The MPEG decoder 54 decodes video and audio encoded in accordance with WAEA Specification 0395, and MPEG encoded at the following resolutions: MPEG-1 at 352×240 (SIF), MPEG-2 at 352×480 (Half D-1), MPEG-2 at 720×480 (Full D-1). The SVDU 34 also supports Constant Bit Rate (CBR) video at a rate of 1.5 Mbps for MPEG-1 material and 3.5 Mbps for MPEG-2 material. These bit rates are for the elemental video stream and do not necessarily include encoded audio, data, or multiplexing overhead. Additionally, the MPEG decoder 54 provides closed captioning and on-screen display. The SVDU 34 supports the decoding of audio that is encoded according to WAEA Specification 0395. The MPEG decoder 54 decodes MPEG-1, Layer II encoded at a rate of 128 kbps single channel or joint stereo, and decodes MPEG audio encoded at a rate of up to 256 kbps. The MPEG decoder 54 is also able to decode material containing multiple languages and is able to select an individual audio stream that, for example, corresponds to the passenger's spoken language as indicated by the passenger via the PCU 32 and/or the touch screen on 51. The MPEG decoder 54 may also support the decoding of MP3 encoded audio (MPEG Layer III). After decoding incoming data, the MPEG decoder 54 sends the decoded data to the video decoder 52 and the audio DAC 80.

Referring again to FIG. 2 and FIG. 3, the SVDU 34 provides sound generation capability. In various embodiments, the SVDU 34 supports audio signals coded in wave, FM synthesis, and midi synthesis formats. The PCI audio interface 78 generates two audio signals (left and right) with a common audio return, which are provided to the audio driver 82. In one embodiment, the audio driver 82 has an output impedance that is less than 50 ohms, with a maximum audio level of 0 dBm into 600 ohms (2.2 Vpp) as specified in WAEA-1289-1 and WAEA-1289-2. The audio driver 82 is capable of producing a +3 dBm signal for up to 10 msec without excessive clipping or distortion. The audio output characteristic of the audio driver 82 in an embodiment of the invention is as shown in the table below.

Audio characteristic

| Total Harmonic | ≦1% | | At 1 Khz, 0 dBm Tone |
|---|---|---|---|
| Channel Crosstalk | ≦−55 | dB | Crosstalk between |
| | | | Left and Right Audio |
| | | | Channel |
| Signal To Noise | ≦−55 | dB | |
| Frequency | +/−3 | dB | From 50 Hz to 12 Khz |
| Response | | | |

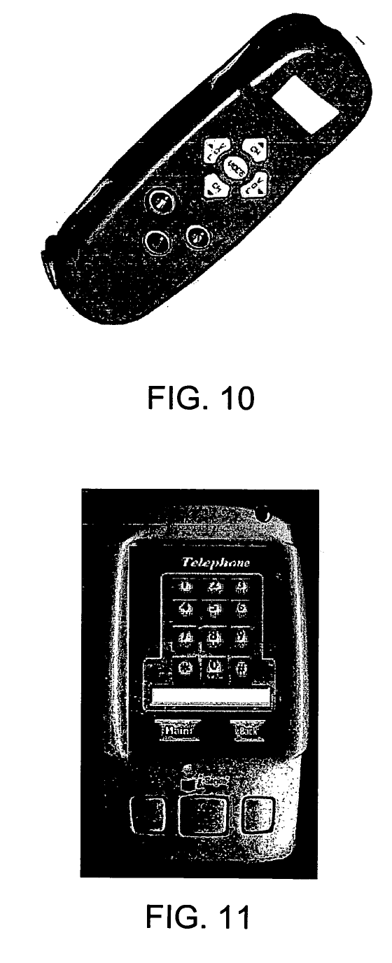

Referring to FIG. 2, various embodiments of the SVDU 34 support user input devices. Examples of possible input devices include: a touch panel, a pointing device (local USB or remote), a game controller (Local USB or remote), a standard 84-key PC keyboard (Local USB or remote), and a credit card reader (with a detachable USB or RS232 connector). If included, the credit card reader will be modular and easily removed by maintenance and repair personnel. With the exception of the touch panel, the interface to all user input devices may be local using the USB host controller 84 or remote using messages over one or more of the LANs 20. The USB host controller 84 may be OHCI version 1.1 with 12 Mbytes full rate. Further examples of input devices include a basic passenger control unit (FIG. 9—left), a game controller (FIG. 9—right), a control unit with a credit card reader and voice over IP capability (FIG. 10), and a passenger control unit with a touchscreen browser and integrated phone (FIG. 11).

In one implementation, the difference between a local or remote user input device is transparent to the application using the input device. To accomplish this, the remote user input device controls are translated by software in the SVDU 34 into a form which makes them appear as if they arrived from a “virtual” USB interface plug.

In an embodiment of the invention, the SVDU 34 is configured with the following interfaces to the SEB 16 and to internal connections such as the backlight inverter 72, touch screen 51a and LCD interfaces:

CONNECTOR TABLE

| | | # of Pins |
|---|---|---|
| Connector | Function/Name | Used |
| J6 (External) | I/O Interface | 15 |
| J4 (Internal) | LCD TFT Panel Interface | 31 |
| J1 (Internal) | LCD LVDS Panel Interface | 14 |
| J3 (Internal) | LCD Backlight Power Interface | 8 |
| J8 (Internal) | LCD Touch Screen Interface | 8 |

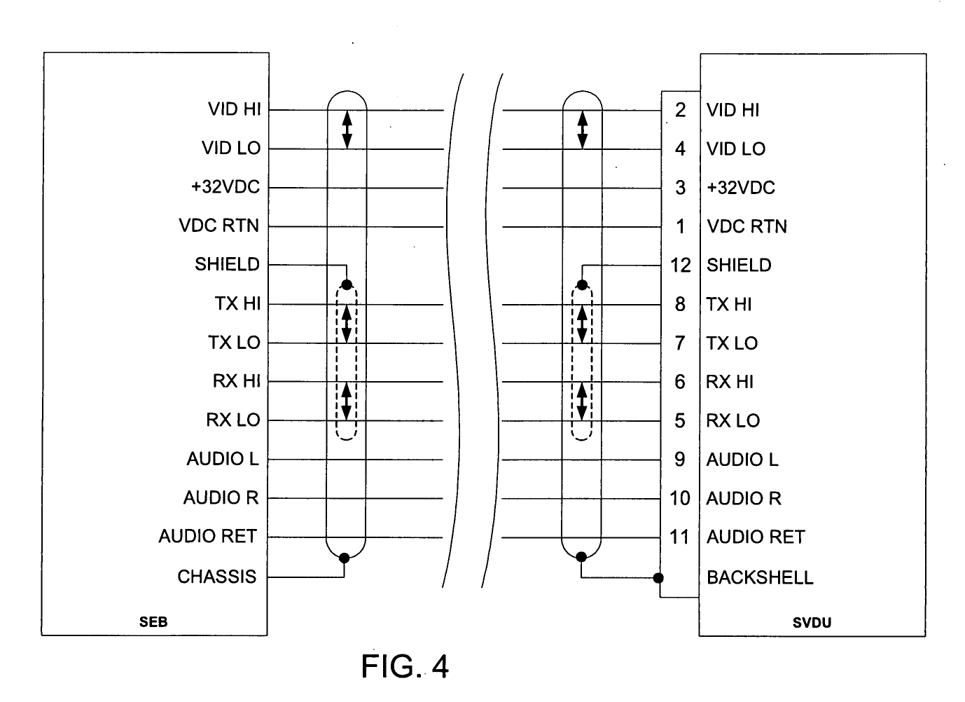

The electrical interface between the SEB 16 and the SVDU 34 according to an embodiment of the invention is illustrated in FIG. 4. Details of the interface (referred to herein as interface J6) are shown in the above table:

J6- SEB INTERFACE CONNECTOR (EXTERNAL)

| Pin | | |
|---|---|---|
| Number | Signal Name | I/O Function Type |
| 1 | VID_HI | Differential Video Input+ |
| 2 | VID_LO | Differential Video Input− |
| 3 | +32 V | Input Power |
| 4 | +32 VRTN | Input Power Return |
| 5 | TX_HI | Differential 10/100BaseT Input+ |
| 6 | TX_LO | Differential 10/100BaseT Input− |
| 7 | RX_HI | Differential 10/100BaseT Output+ |
| 8 | RX_LO | Differential 10/100BaseT Output− |
| 9 | AUD_L | Audio Left Channel Output |
| 10 | AUD_R | Audio Right Channel Output |
| 11 | AUD_RTN | Audio Return |
| 12 | CHAS_GND | Chassis Ground |
| 13 | QUAD:SHIELD | Differential 10/100BaseT Shield Ground |
| 14, 15 | N/C | No Connection |

Details of the J4 connector are shown in the following table:

J4 - 8.4″ LCD TFT INTERFACE CONNECTOR (INTERNAL)

| Pin Number | Signal Name | I/O Function Type |
|---|---|---|
| 1 | GND | Ground |
| 2 | GND | Ground |
| 3 | NCLK | Sampling Clock |
| 4 | GND | Ground |
| 5 | R0 | Red Display Data 0 (LSB) |
| 6 | R1 | Red Display Data 1 |
| 7 | R2 | Red Display Data 2 |
| 8 | R3 | Red Display Data 3 |
| 9 | R4 | Red Display Data 4 |
| 10 | R5 | Red Display Data 5 (MSB) |
| 11 | GND | Ground |
| 12 | G0 | Green Display Data 0 (LSB) |
| 13 | G1 | Green Display Data 1 |
| 14 | G2 | Green Display Data 2 |
| 15 | G3 | Green Display Data 3 |
| 16 | G4 | Green Display Data 4 |
| 17 | G5 | Green Display Data 5 (MSB) |
| 18 | GND | Ground |
| 19 | B0 | Blue Display Data 0 (LSB) |
| 20 | B1 | Blue Display Data 1 |
| 21 | B2 | Blue Display Data 2 |
| 22 | B3 | Blue Display Data 3 |
| 23 | B4 | Blue Display Data 4 |
| 24 | B5 | Blue Display Data 5 (MSB) |
| 25 | GND | Ground |
| 26 | ENAB | Compound Synchronization Signal |
| 27 | VDD | +3.3 V Power Supply |
| 28 | VDD | +3.3 V Power Supply |
| 29 | GND | Ground |
| 30 | GND | Ground |

Details of the J1 connector are shown in the following table:

J1- LCD LVDS INTERFACE CONNECTOR (INTERNAL)

| Pin Number | Signal Name | I/O Function Type |
|---|---|---|
| 1 | LCD_PWR | LCD Power (+3.3 V/+5.0 V) Output |
| 2 | LCD_PWR | LCD Power (+3.3 V/+5.0 V) Output |
| 3 | DGND | Digital Ground |
| 4 | DGND | Digital Ground |
| 5 | TXOUT0_LL | Differential LVDS Data 0 Output− |
| 6 | TXOUT0_HH | Differential LVDS Data 0 Output+ |
| 7 | TXOUT1_LL | Differential LVDS Data 1 Output− |
| 8 | TXOUT1_HH | Differential LVDS Data 1 Output+ |
| 9 | TXOUT2_LL | Differential LVDS Data 2 Output− |
| 10 | TXOUT2_HH | Differential LVDS Data 2 Output+ |
| 11 | TXCLKOUT_LL | Differential LVDS Clock Output− |
| 12 | TXCLKOUT_HH | Differential LVDS Clock Output+ |
| 13 | DGND | Digital Ground |
| 14 | DGND | Digital Ground |

Details of the J3 connector are shown in the following table:

J3- LCD BACKLIGHT POWER INTERFACE
CONNECTOR (INTERNAL)

| Pin Number | Signal Name | I/O Function Type |
|---|---|---|
| 1 | +12 V_BL | Backlight Power +12 V Output |
| 2 | +12 V_BL | Backlight Power +12 V Output |
| 3 | AGND | Analog Ground |
| 4 | AGND | Analog Ground |
| 5 | +5 V | +5 V Power Output |
| 6 | DIM | Dimming Control Output |
| 7 | AGND | Analog Ground |
| 8 | AGND | Analog Ground |

Details of the J8 connector are shown in the following table:

J8- LCD TOUCH SCREEN INTERFACE
CONNECTOR (internal)

| Pin Number | Signal Name | I/O Function Type |
|---|---|---|
| 1 | Ye− | Y-Axis Excitation Output− |
| 2 | Ys− | Y-Axis Sense Input− |
| 3 | Ys+ | Y-Axis Sense Input+ |
| 4 | Ye+ | Y-Axis Excitation Output+ |
| 5 | Xe− | X-Axis Excitation Output− |
| 6 | Xs− | X-Axis Sense Input− |
| 7 | Xs+ | X-Axis Sense Input+ |
| 8 | Xe+ | X-Axis Excitation Output+ |

According to an embodiment of in invention, the SVDU 34 executes a software driver for the touch screen 51a, which allows the touch screen 51a to perform the following functions: cursor movement and left click down (indicated by applying pressure to a location on the touch screen 51a), left click up indication (indicated by removing pressure from a location on the touch screen 51a), drag (indicated by moving the pressure location without removing the pressure from the touch screen 51a).

When implemented with a pointing device, the SVDU supports the following inputs from the pointing device: cursor movement indications, left click make (down) and break (up) indications, right click make (down) and break (up) indications, scroll wheel movement indications (scroll up, scroll down). When implemented with a game controller, the SVDU 34 supports the following inputs from the game controller: joystick movement, buttons designated X, Y, A, B, start, and select, and an “X-Pad” providing up, down, left, right and combination movement.

In various embodiments of the invention, the SVDU 34 supports maintenance functions of the system 10, examples of which will now be described. The SVDU 34 provides a Config Check function that is compatible with the configuration identification and verification process of the system 10. When executing the Config Check function, the SVDU 34 provides the following information about itself to the system 10 via the LAN 20: its part number, revision status, modification level, serial number, part number(s) of the software component(s) included in the hardware configuration, part number(s) of the aircraft loadable software component(s), and part number(s) of the aircraft loadable database component(s). Also, the SVDU 34 performs a power-on self-test (POS)T each time it powers up or reboots. The SVDU 34 includes an internal reset switch that may be used to reboot. The internal reset switch resets main processor and associated circuitry of the SVDU 34.

During the POST, the SVDU 34 tests its internal components. For example, the SVDU 34 performs a memory test of random access memory (RAM) and flash memory. The POST is performed without producing audio signals, since the resulting noise would be objectionable to passengers wearing their headsets. Thus, the SVDU avoids generating pops, buzzes, tones or sending any other kind of audio signals to the headset during the POST. The POST may be performed in several stages. For example, the lowest level software (such as the BIOS) might perform tests that verify the ability of the low level functions of the SVDU to work, such as downloading, IP sequencing, and configuration checking. The SVDU may perform higher level testing under the control of the aircraft-modifiable software.

The SVDU 34 performs a continuous background monitoring of its interfaces and internal functions. The results of the background monitoring will be provided to the system 10 over the LAN 20 in accordance with the monitoring procedure of the system 10. The background monitoring will be non-intrusive in that it will be performed without changes to the operational state of the SVDU 34 (e.g. volumes and channels will not be changed) and will have minimal effect on the normal operation of the SVDU 34. Preferably, this background monitoring will take no more than 5% of system resources (processor time, memory). The background monitoring provides information regarding whether the POST passed or failed, the Input DC voltage, and other non-intrusive health checks. The SVDU 34 provides backlight on/off status and the video indicator status to the SEB 16 by message sent via the LAN 20. The SVDU 34 also provides a Power On Indicator to indicate the power status (ON or OFF) of the SVDU 34. Additionally, the SVDU 34 records its elapsed ON time in non-volatile memory. This data will be provided to the system 10 if the system 10 queries the SVDU 34. The data may also be retrieved from the LCD monitor via an on-screen display. The elapsed ON time cannot be reset except by maintenance or factory personnel.

The SVDU 34 supports an intrusive test that is performed by built-in test equipment (BITE) of the system 10. The intrusive test is conducted based on a set of centrally initiated actions, measurements, recording of data, and transfer of recorded data. The system 10 obtains intrusive test results from a combination of the results from the Config Check and continuous monitoring, with the analysis being performed on the records obtained from the intrusive test process.

The SVDU also supports a static test mode that is initiated at the request of the system 10. The intent of static test mode is to provide a mechanism by which functions un-testable by automatic means (such as VDU color and PCU buttons) can be manually tested.

The SVDU 34 accepts a differential video input signal from the SEB 16. This signal terminates within the SVDU at 100 ohms. The SVDU 34 also accepts nominal +32 VDC unregulated power from the SEB 16 and converts it as necessary to power the internal hardware of the SVDU 34. The SVDU 34 is capable of operating with the input DC power anywhere in the range of +18 VDC to +36 VDC with a maximum ripple of 100 mVp-p. The SVDU 34 is also capable of withstanding a 40 Volt surge for as long as 100 msec.

The SVDU 34 provides a full duplex 10/100BaseT Ethernet interface to the SEB 16. Any audio created within the SVDU 34 is provided to the SEB 16. The audio interface includes a Left audio signal (AudL) a right audio signal (AudR) and a common reference audio return (AudRtn). The output impedance of the audio driver 82 (FIG. 2) is less than 50 Ohms. A maximum volume signal generated by the SVDU 34 has an output level of 0 dBm into 600 Ohms (2.2 Vpp) as specified in WAEA-1289-1 and WAEA-1289-2. The audio driver 82 is capable of producing a +3 dBm signal for up to 10 msec without excessive clipping or distortion.

In an embodiment of the invention, the LCD 51 of the SVDU 34 has the following video display characteristics:

Video Display Characteristics

| Parameter | Specification | Specification | Specification |
|---|---|---|---|
| View Size | 8.4″ | 10.4″ | 15.4″ |
| (diagonal) | | | |
| LCD Resolution | SVGA (800 × 600) | SVGA (800 × 600) | XGA (1024 × 768) |
| LCD Color Depth | 6 bit/color - RGB | 6 bit/color - RGB | 6 bit/color - RGB |
| Contrast Ratio | 100:1 minimum | 100:1 minimum | 100:1 minimum |
| View Angle | Horizontal: ±40° | Horizontal: ±60° | Horizontal: ±55° |
| (without privacy | Vertical: | Vertical: | Vertical: |
| filter) | 40° (viewing from above) | 50° (viewing from above) | 40° (viewing from above) |
| | 23° (viewing from below) | 23° (viewing from below) | 23° (viewing from below) |
| Brightness | >100 | >100 | >100 |
| (without privacy | | | |
| filter or touchscreen) - cd/m² | | | |
| Aspect Ratio | 4:3 | 4:3 | 4:3 |

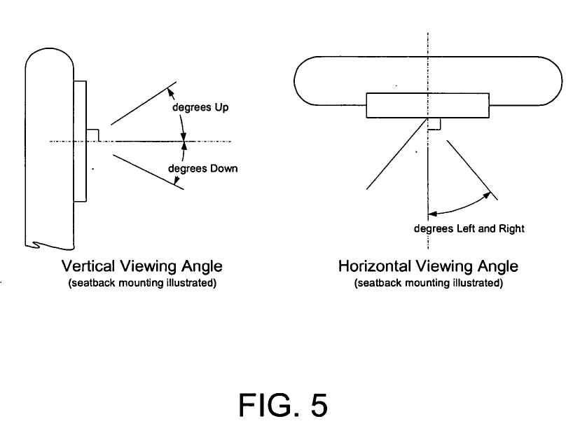

Viewing angles of the LCD 51 according to an embodiment of the invention are shown in the table below, and are also illustrated in FIG. 5.

viewing angle

| | |
|---|---|
| Vertical Viewing Angles | Up (viewed from above): 40 degrees |
| (8.4″ LCD) | Down (viewing from below): 70 degrees |
| Horizontal Viewing | 55 degrees left and right. |
| Angles (8.4″ LCD) | |
| Vertical Viewing Angles | Up (viewed from above): 50 degrees |
| (10.4″ LCD) | Down (viewing from below): 50 degrees |
| Horizontal Viewing | 60 degrees left and right. |
| Angles (10.4″ LCD) | |

The Average Luminance of white on the LCD 51 in an embodiment of the invention is shown in the table below.

Luminance

| Avg. Luminance | cd/m² (typical) |
|---|---|
| 8.4″ | 450 |
| 10.4″ | 230 |

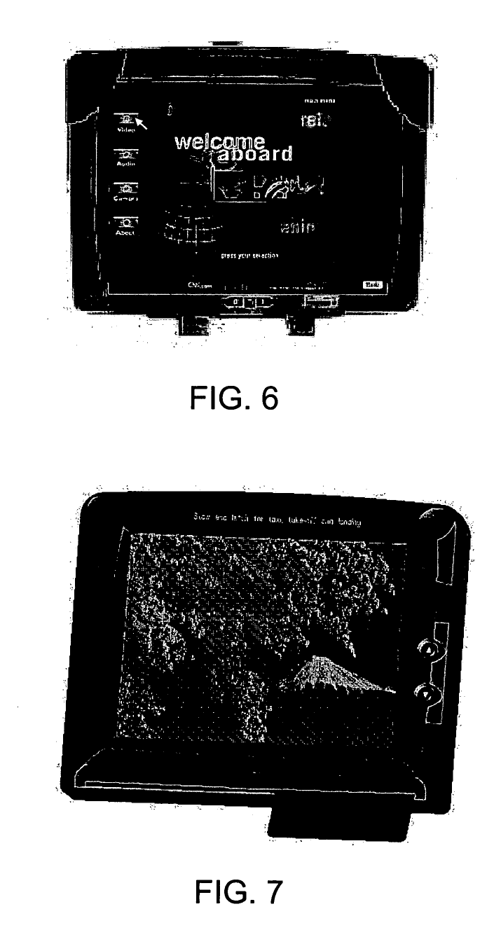

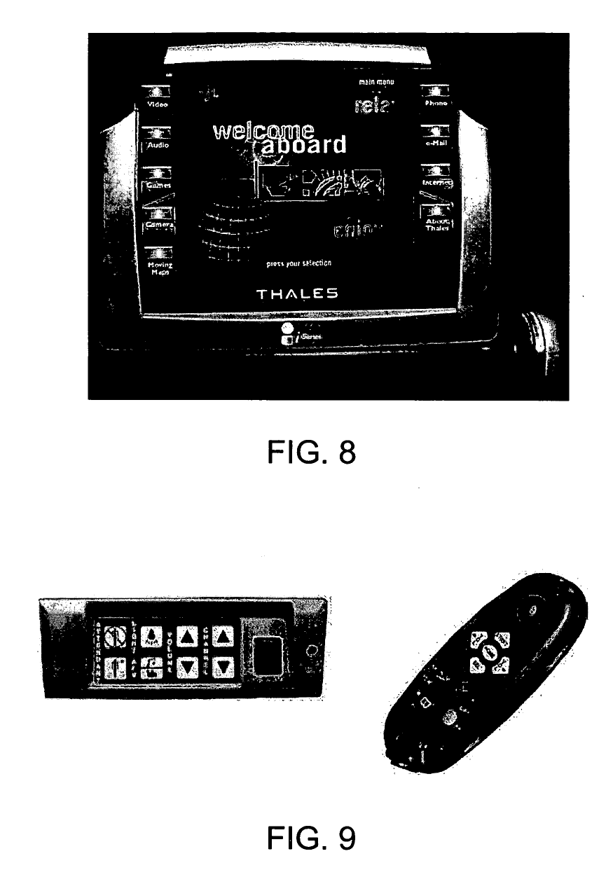

The LCD may be mounted on a seat back, as shown in FIG. 6, or mounted to a seat arm, as shown in FIGS. 7 and 8. The LCD may also be mounted to a bulkhead or to any other part of an aircraft interior.

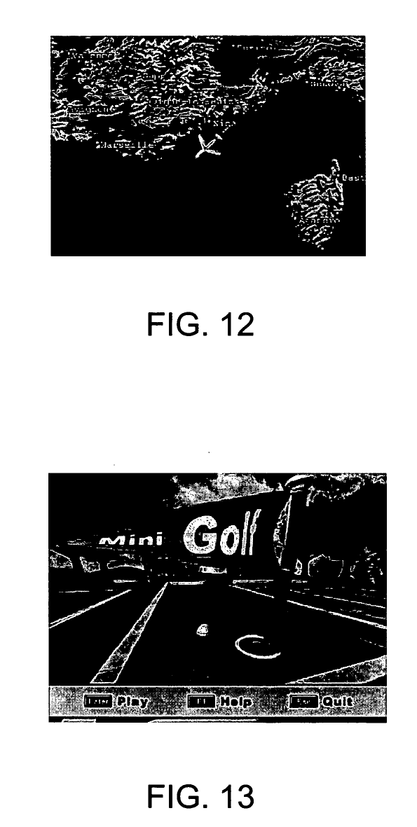

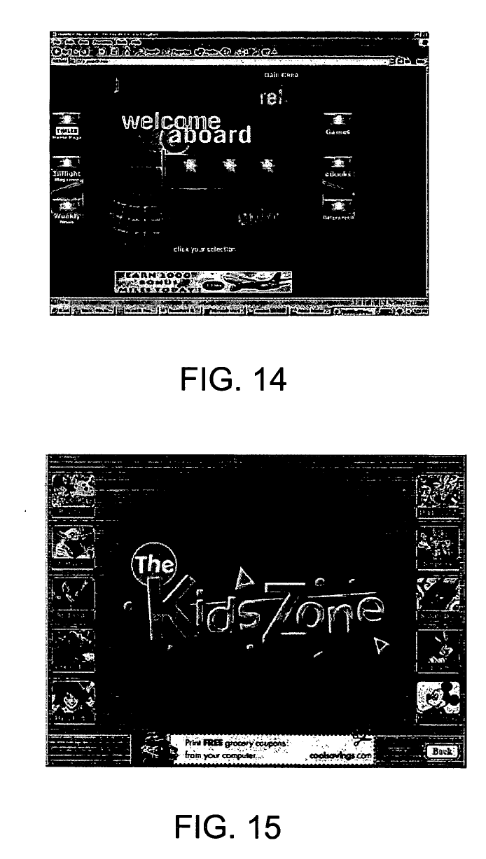

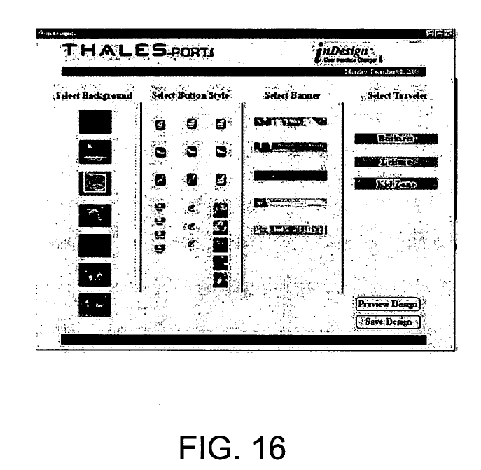

As previously discussed, a wide variety of types of content can be delivered to the SVDU using the system described herein. For example, the opening screen might be a menu, such as shown in FIG. 8. The passenger could then use the menu to choose to order an on-demand video, order on-demand audio, play networked games (e.g. FIG. 13), view a live-camera feed, view a moving map showing the location of the aircraft (e.g. FIG. 12), use a VoIP phone, access email, access the internet, or read literature about the vendor who supplied the multimedia content delivery system. Another example of an opening menu is shown in FIG. 14, in which the passenger could additionally view an in-flight magazine, view a weekly news program, order an eBook, or view general references. As shown in FIG. 15, a kids-oriented menu may be displayed, from which children's movies could be ordered. Finally, each passenger's display may be customized using a web design tool, such as that shown in FIG. 16. Different backgrounds, button styles, and banner ads may be configured using the tool. Additionally, different types of passengers could receive different types of menus. For example, a different menu could be designed for business travelers, leisure travelers, and kids.

It can thus be seen that a new and useful system for providing multimedia content ot airline passengers has been described. Note that there are many possible variations of the embodiments described herein that fall within the scope of the following claims. Additionally, every implementation and configuration described herein is meant to be an example only and should not be taken as limiting the scope of the claims. Also, note that he use of the terms “a” and “an” and “the” and similar referents in the context of describing the invention (especially in the context of the following claims) are to be construed to cover both the singular and the plural. Furthermore, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context.

1. A system for providing multimedia content to a passenger on an aircraft, the system comprising:
a video display unit disposed proximate to a seat to which the aircraft passenger is assigned, the video display unit comprising a display screen and a video decoder; and
a user input device communicatively linked to the video display unit, wherein, in response to the aircraft passenger manipulating the user input device to select an on-demand video, signals representing an on-demand video are transmitted to the video display unit, and received by the video decoder,
wherein the video decoder decodes the signals, thereby permitting the on-demand video to be displayed on the display screen.

2. The system of claim 1, wherein the user input device comprises a touch panel coupled to the display screen of the video display unit.

3. The system of claim 2, wherein the video display unit further comprises a processor, wherein, in response to physical contact by the passenger, the touch panel generates signals that are transmitted to the processor, which the processor interprets as mouse-generated commands.

4. The system of claim 1, wherein the video display unit further comprises a digital controller that includes the video decoder, the digital controller further comprising a compressed digital video decoder that receives compressed digital video signals and decodes the compressed digital video signals, thereby permitting moving images to be displayed on the video screen.

5. The system of claim 4, wherein the compressed digital video signals are MPEG encoded, the system further comprising a local area network located on the aircraft, wherein the video display unit receives the MPEG encoded compressed digital video signals via the local area network.

6. The system of claim 5, the system further comprising a head end unit in which MPEG content is stored, wherein the MPEG encoded compressed digital video signals that are received by the video display unit represent the MPEG content.

7. The system of claim 1, further comprising a local area network, wherein the video display unit is communicatively linked to the local area network, wherein the user input device is a game controller, and wherein the video display unit obtains one or more computer games via the network and provides them to the passenger.

8. The system of claim 1, further comprising a local area network located on the aircraft, wherein the video display unit is communicatively linked to the local are network, and wherein the system assigns a network address to the video display unit over the local area network.

9. The system of claim 1, further comprising a local area network located on the aircraft, wherein the video display unit is communicatively linked to the network, and wherein the video display unit performs a self test, and transmits the results of the self test over the local area network.

10. The system of claim 1, further comprising a credit card reader communicatively linked to the video display unit.

11. A system for providing multimedia content to a plurality of passengers on an aircraft, each passenger being assigned to one of a plurality of seats of the aircraft, the system comprising:
a plurality of video display units, each associated with, and proximate to, one of the plurality of seats, wherein each video display unit comprises a display screen and a video decoder;
a plurality of user input devices, each communicatively linked with one of the plurality of video display units;
a data network located on the aircraft, wherein each of the plurality of user input devices is communicatively linked to the data network; and
a head end unit communicatively linked to the data network, wherein a plurality of on-demand videos are electronically stored in the head end unit,
wherein, in response to an aircraft passenger of the plurality of aircraft passengers manipulating the user input device that is communicatively linked to the video display unit associated with the seat to which the aircraft passenger is assigned, signals representing a on-demand video of the plurality of on-demand videos are transmitted to that video display unit over the data network, and are received by the video decoder of that video display unit, and
wherein the video decoder decodes the signals, thereby permitting the on-demand video to be displayed on the display screen of that video display unit.

12. The system of claim 12, wherein the data network comprises an Ethernet network and a plurality of RF video links, wherein each of the plurality of display units is communicatively linked to the Ethernet network and wherein the video display unit at which the aircraft passenger manipulates the user input device receives the signals representing the on-demand video receives said signals via one or more of the plurality of RF video links.

13. The system of claim 12, wherein the data network comprises a local area network, and at least on of the plurality of on-demand videos is an MPEG formatted video, and wherein the signals transmitted to the video display unit represent the MPEG formatted video, and are transmitted via the local area network.

14. The system of claim 12, wherein the data network comprises a local area network, and wherein each of the plurality of video display units is assigned a network address on the local area network.

15. The system of claim 12, wherein the data network comprises a local area network, and wherein one or more games are delivered to one or more of the video display units via the local area network, and wherein the system further comprises one or more game controllers communicatively linked to one or more of the video display units, thereby permitting one or more of the passengers to play the one or more delivered games.

16. The system of claim 12, wherein each of the plurality of video display units as manufactured comprises software for facilitating network address assignment, software for reporting the configuration of the video display unit, and software for downloading additional software.

17. The system of claim 16, wherein the additional software comprises software for continuously monitoring interfaces and internal functions of the video display unit.

18. The system of claim 17, wherein the additional software further comprises software that is specific to a particular customer that is purchasing the system.

19. The system of claim 12, wherein each of the video display units is mechanically coupled to one seat of the plurality of seats.

20. A system for providing video and audio content, the system comprising:
an aircraft comprising a fuselage;
a floor disposed within the fuselage;
a plurality of passenger aircraft seats coupled to the floor;
a local area network having a plurality of nodes that are distributed throughout the aircraft;
a head end server communicatively linked to the local area network at one of the plurality of nodes;
a plurality of video display units, each video display unit of the plurality being coupled to a seat of the plurality of seats and communicatively linked to the local area network at one of the plurality of nodes; and
a plurality of RF video links, wherein the head end server delivers on-demand video content to one or more of the video display units via one or more of the RF video links,
wherein each video display unit comprises a processor, a display screen, and a touch-sensitive interface disposed on the display screen,
wherein, in response to a passenger touching the display screen, the head end server transmits on-demand video to the video display unit, and
wherein the video display unit transmits data representing the hardware status of the video display unit to the head end server via the local area network.
